(19) United States
(12) Patent Application Publication
(10) Pub. No.: US 2009/0034425 A1
(43) Pub. Date: Feb. 5, 2009

(54) CALL CASE CONTROLLED BLER TARGET SETTING

(75) Inventors: Fredrik Jansson, Sundbyberg (SE); Rutger Andersson, Kista (SE); Michael Anehill, Solna (SE); Karl Hellwig, Wonfurt (DE)

Correspondence Address: NIXON & VANDERHYE, PC, 901 NORTH GLEBE ROAD, 11TH FLOOR, ARLINGTON, VA, 22203, US

(73) Assignee: TELEFONAKTIEBOLAGET LM ERICSSON, Stockholm (SE)

(21) Appl. No.: 10/581,246

(22) PCT Filed: Dec. 3, 2003
(86) PCT No.: PCT/SE2003/001869

§ 371 Date: Oct. 1, 2008

(51) Int. Cl. G06F 11/00; H04B 7/216; H04B 7/005; H04M 1/00

(52) U.S. Cl. 370/252; 370/342; 370/278; 455/522

(57) ABSTRACT

A method and system are disclosed for call case controlled block error rate (BLER) or bit error rate (BER) target setting in WCDMA and other CDMA technologies for Mobile to Mobile (MTM) and Mobile to Public Switched Telephone Network (MTPSTN) communication systems, whereby first an overall BLER/BER target value is defined.

### TECHNICAL FIELD

The present invention relates to mobile uplink and downlink power control and more particularly to a block/bit error rate (BLER/BER) measurement for obtaining an optimum power setting.

### BACKGROUND

In Wideband Code Division Multiple Access (WDCMA) (and other code division multiple access technologies like CDMA2000) a first power control mechanism is an essential part of the air interface, see [1] chapter 9.2. There are differences between the uplink and the downlink power control, but for the understanding of the invention these differences are of no importance. The following description will be valid for both links.

The ideas described here may also be applied (with some adaptations) to a GMSK Gaussian Minimum Shift keying and EDGE (Enhanced Data rates for GSM Evolution) Radio Access Network (GERAN) providing radio access with slower power control or any other modern cellular radio access.

The so-called inner loop of the power control algorithm tries to keep the received signal-to-interference-ratio (SIR) at a specific level (SIR target). If SIR becomes to low the power control commands the transmitter at the other end of the link to raise its output power in order to keep SIR and thereby the quality of received signal at an acceptable level. If SIR on the other hand is too high the transmitter is commanded to lower its output power in order not to cause unnecessary interference to other users.

To further increase the efficiency of the power control there is also an outer loop of power control. When e.g. a speech coded block is sent over the air interface cyclic redundancy checksums (CRC) are calculated on parts of the speech block. The checksums are sent together with the speech block and are being used by the receiver to detect erroneous blocks. The outer loop of the power control algorithm uses the block error rate measurement (BLER) to adjust the SIR target so a level that gives a specific BLER (the BLER target). If the measured BLER is lower than the BLER target, then the outer loop changes the SIR target to a lower value and if the measured BLER is higher than the BLER target, then the SIR target will be raised.

Thus under normal operating conditions the actual BLER of a WCDMA speech call is close to the BLER set by the BLER target parameter in the WCDMA system.

### State of the Art

Selecting a value for the -BLER target is a trade off between quality and radio cell capacity. A lower BLER target gives a better speech quality, but at the expense of higher transmitter power and therefore lower cell capacity., i.e. number of simultaneous users in the cell in this radio link direction.

### Problem to be Solved

Today the BLER target is set for all radio links without considering if the call is a Mobile to Public Switched Telephone Network (MTPSTN) call or if it is a Mobile to Mobile (MTM) call.

In a Mobile to PSTN call there is one radio link in each direction of the path between the end points, but in a Mobile to Mobile call there are two radio links in each direction. At the BLER levels that give acceptable speech quality (e.g. around 1%) one can approximately add the BLER from the two radio links to get the total BLER in a Mobile to Mobile call. This means that if the BLER target is set to 1% for each radio link, then the resulting total BLER in a Mobile to Mobile call will be about 2%.

When a common unique BLER target is to be selected for MTPSTN and MTM calls, then a compromise has to be done, either the quality in Mobile to Mobile (MTM) calls will be less than desired or the capacity for Mobile to PSTN calls will be less than possible.

### SUMMARY OF THE INVENTION

A method and a system are disclosed for case controlled block error rate (BLER) or bit error rate (BER) target setting in a Code Division Multiple Access (CDMA) Mobile to Mobile (MTM) and Mobile to Public Switched Telephone Network (MTPSTN) communication system, whereby for instance an overall BLER/BER target value will be defined. A decision is made whether the call is of the type MTM or MTPSTN. This may be done for instance by inspecting certain frame types only occurring in the downlink if there is another mobile link in the path. A first BLER/BER value for the uplink or the first link is then determined by counting bad frames and using remaining difference to the overall BLER/BER target value for the setting of the second BLER/BER value for the downlink or second link. Initially the first BLER/BER value of the uplink may be set to a maximum value equal to half the total BLER/BER target value.

### DESCRIPTION OF THE INVENTION

The following description is focussed on the circuit switched speech service, but is equally applicable to video telephony and any other service where the quality will be dependent on the quality of the received information.

The solution of the presented problem should be to have different BLER/BER target values for mobile to PSTN calls and for Mobile to Mobile calls, the ideal solution would be to have different BLER/BER targets for each individual link (two uplinks, two downlinks) in order to achieve always the same total BLER/BER in all call cases.

For the uplink direction, which is always the first radio link in this speech path direction, it is simple to detect the speech frames corrupted by this radio link: These are generally all bad frames. In case of Mobile to PSTN calls the BLER/BER is set to the desired value for the overall BLER. In case of Mobile to Mobile calls the BLER/BER for this first radio link may in a first solution be set to just the half of the desired value for the overall BLER/BER.

For the downlink direction, which is the first radio link in this speech path direction for PSTN to Mobile calls, but which is the second radio link in this speech path direction for Mobile to Mobile calls, it is not that easy to differentiate between the bad speech frames resulting from errors of the first radio link and the bad speech frames resulting from the errors of the second radio link. But this differentiation is important, otherwise the (outer) power control loop could get into undesired or even unstable behaviour.

In the case of GERAN the differentiation between both error sources may be made within the mobile station based on the way the CRC calculation is defined for the downlink radio interface, see TS 48.060 or TS 48.061. Bad speech frames arriving by downlink at the Base Tranceiver Station (BTS) will either be replaced by “Layer 2 Fill Frames” or be sent down to the mobile station, but with inverted CRC bits.

For Universal Mobile Telecommunication System (UMTS) Terrestrial Radio Access Network (UTRAN) the differentiation is possible within the mobile station due to the fact that either the Radio Network Controller (RNC) disregards bad frames completely, then the User Equipment (UE) will not receive a speech frame, or the Node B inverts the CRC bits for bad speech frames (however this is not yet standardised).

In both GERAN and UTRAN, another way to differentiate the two error sources is possible within the BTS, respectively Node B, by just counting the bad frames arriving there from the distant radio link and subtracting these bad frames from the overall number of bad frames as reported by the mobile station. This solution, where the differentiation is done within the BTS (Node B) is the preferred on in case no standardisation is achieved, because it does not require changes in the mobile stations.

In case of PSTN to Mobile calls the BLER/BER is set to the desired value for the overall BLER/BER. In case of Mobile to Mobile calls the BLER/BER for this second radio link may in a first solution be set to just the half of the desired value for the overall BLER/BER. Alternative solutions to set the BLER/BER target values for Mobile to Mobile calls take advantage of the fact that the interference situations in both radio cells are typically not equal. Remember that what counts for the end-user is the overall BLER/BER, which must stay below a certain limit (e.g. 1%) to satisfy the end-user. But it does not matter if one radio link is completely error free (at the extreme) and the other radio link produces all the allowed errors.

Without a feedback from the second radio link back to the first radio link (and such a feedback is currently not standardised), it is impossible to find a “symmetrical” solution, where the BLER/BER is distributed in a “fair” manner. But this is not a big disadvantage.

Typically the uplink direction has to carry less overall traffic than the downlink direction (mainly due to the increasing usage of streaming data retrieval and Internet browsing) and therefore more transmitter power may be allowed to the individual uplink. The BLER/BER target for the uplink can be set to a lower value. It is possible that the first radio link adapts its BLER/BER target value for the uplink permanently according to the changing load and interference situation in its uplink direction. The second downlink can easily determine the BLER/BER from the first radio link by counting the bad frames and can then use all the remaining difference to the overall BLER/BER target for its BLER/BER target setting. In this way the load in the second cell in downlink direction can be reduced without violating the speech quality target.

This second alternative solution is therefore the preferred one, because it optimises the critical downlink direction. It has another great advantage: It works automatically for all call types, PSTN to Mobile and Mobile to Mobile, because it just uses the remaining BLER/BER difference for its own target setting. In case of PSTN to Mobile calls the first access is typically completely error free. One problem might arise in case of MTPSTN calls in the sense that BLER/BER target on the uplink radio channel might in average be set too low to allow the necessary headroom for a potential second downlink radio channel, but which is not present in MTPSTN calls.

A further advantage of the second solution is that it can take into account also errors in the transmission in the fixed part of the connection. These errors are typically rare, but may increase in busy hours due to increased traffic and load (especially when packet base transport (e.g. Internet Protocol, IP or Asynchronous Transfer Mode, ATM) is used or may increase in bad weather conditions (e.g. when microwave links are used).

Consequently an increased capacity and/or speech quality will be achieved in a WCDMA system as well as any other Radio Access Network (RAN)., e.g. GERAN.

The implementation of the method and system according to the present inventive idea includes the planning and realisation of transcoder free operation(TrFO) or tandem free operation (TFO) where the system is aware of if a call is a Mobile to PSTN or Mobile to Mobile call. It is also possible to detect a Mobile to Mobile call by inspecting the frame type of the speech data since certain frame types (for instance SPEECH_BAD, SID_BAD) only occurs in the downlink data if there is another mobile link in the path. Another possibility to detect a Mobile to Mobile call is by number analysis, i.e. knowledge of if a called telephone number belongs to a fixed line service or a mobile telephone service.

Thus, this is applicable for WCDMA and CDMA2000 and future systems that include a power control similar to WCDMA. It can also be used for other WCDMA services like videotelephony and can be applied also in systems with slower power control. The basic principle of the invention is not limited to the use of the block error rate BLER to control the transmission power. It is equally applicable for other parameters like for example the bit error rate, BER.

### REFERENCES

[1] H. Holma, A. Toskala “WCDMA for UMTS”, John Wiley&Sons, 2001

1. A method for call case controlled block error rate (BLER) or bit error rate (BER) target setting for a radio link in a Code Division Multiple Access (CDMA) Mobile to Mobile (MTM) and Mobile to Public Switched Telephone Network (MTPSTN) communication system, characterised by the step of:
defining a desired total BLER/BER target value;
detecting if a call is MTM or MTPSTN; and
in case of a MTM call controlling the BLER/BER on a second link to give a total BLER/BER according to the total BLER/BER target.

2. The method according to claim 1, characterised by the further step of:
detecting if a call is MTM or MTPSTN by inspecting frame types to be sent on the second link.

3 The method according to claim 1, characterised by the further step of:
controlling BLER/BER of a first link and a second link and separately setting a first BLER/BER target for the first link and a second BLER/BER target the second link such that a sum of the first and second BLER/BER targets will be equal to the total BLER/BER target.

4. The method according to claim 3, characterised by the further step of:
setting the first BLER/BER target for the first link to 50% of the total BLER/BER target.

5. The method according to claim 3, characterised by the further step of:
setting the second BLER/BER target to a difference between the total BLER/BER target and an estimated BLER/BER in blocks to be sent on the second link.

6. A method for case controlled block error rate (BLER) or bit error rate (BER) target setting for a radio link in a Code Division Multiple Access (CDMA) Mobile to Public Switched Telephone Network (MTPSTN) communication system, characterised by the step of:
defining a desired total BLER/BER target value;
estimating BLER/BER of blocks to be sent on a downlink; and
controlling BLER/BER on a second link to give a total BLER/BER equal to the desired total BLER/BER target.

7. The method according to claim 6, characterised by the further step of:
controlling BLER/BER of the second link separately using a difference between the desired total BLER/BER and an estimated BLER/BER in the blocks to be sent on the downlink as the BLER/BER target for the second link.

8. A system for case controlled block error rate (BLER) or bit error rate (BER) target setting in Mobile to Mobile (MTM) and Mobile to Public Switched Telephone Network (MTPSTN) communication using Code Division Multiple Access (CDMA), characterised in
that a desired overall BLER/BER target value is defined for the system;
a detection of a call being MTM or MTPSTN; and in case of a MTM call controlling the BLER/BER on a second link to give a total BLER/BER according to the total BLER/BER target.

9. The system according to claim 8, characterised in that
a MTM or MTPSTN call is detected by an inspection of frame types to be sent on the second link.

10. The system according to claim 8, characterised in that BLER/BER of a first link and the second link is controlled and that a first BLER/BER target and a second BLER/BER target are separately set such that a sum of the first and second BLER/BER targets will be equal to the total BLER/BER target.

11. The system according to claim 10, characterised in that
BLER/BER for the first link is set to 50 % of the total BLER/BER target.

12. The system according to claim 10, characterised in that
the second BLER/BER target is set to a difference between the total BLER/BER target and an estimated BLER/BER in data to be sent on the second link.

13. A system for call case controlled block/bit error rate (BLER/BER) target setting in Mobile to Public Switched Telephone Network (MTPSTN) using Code Division Multiple Access (CDMA), characterised in that
a desired overall BLER/BER target value is defined for the communication;
BLER/BER of blocks or bits to be sent on a second link is estimated; and
BLER/BER on the second link is controlled to give a total BLER/BER equal to the desired total BLER/BER target.

14. The system according to claim 13, characterised in that
BLER of the second link is controlled separately by using a difference between the desired total BLER/BER and an estimated BLER/BER in data to be sent on the second link as the BLER/BER target for the downlink.
